(19) United States
(12) Patent Application Publication
(10) Pub. No.: US 2006/0223565 A1
(43) Pub. Date: Oct. 5, 2006

(54) Method to optimize forward link capacity from a mixed population of single- and dual-diversity mobile stations

(75) Inventors: Asif D. Gandhi, Iselin, NJ (US); Mathew Thomas, Madison, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/094,608

(22) Filed: Mar. 30, 2005

(51) Int. Cl. H04B 7/00; H04Q 7/20

(52) U.S. Cl. 455/522

(57) ABSTRACT

A method for optimizing the capacity of a forward link in a cellular telecommunications network involves dynamically setting the minimum gain level on the forward link for each mobile station, based each mobile station's individual performance. The cellular network has one or more base stations and a mixed population of single-diversity mobile stations and dual-diversity mobile stations. In communicating with a particular mobile station, the gain level of the transmission over the forward link is monitored at the base station. The base station also monitors the reverse link for a power measurement report message (“PMRM”) sent by the mobile station. If the gain level stays at or close to a minimum gain level for a certain time period, and if no PMRM″s are received during that time period, then the base station reduces the minimum gain level by a set amount. The reduction in the minimum gain level can be triggered based on other factors, such as the forward link frame error rate.

### FIELD OF THE INVENTION

The present invention relates to telecommunications and, more particularly, to wireless communications systems.

### BACKGROUND OF THE INVENTION

A typical cellular telecommunications network (e.g., mobile phone network) includes one or more fixed base stations having various transceivers and antennae for radio communications with a number of distributed mobile stations (e.g., mobile phones). The base stations are in turn connected to a mobile switching center (“MSC”), which acts as the interface between the wireless/radio end of the cellular network and a public switched telephone network or other network(s), including performing the signaling functions necessary to establish calls or other data transfer to and from the mobile stations.

Various methods exist for conducting wireless communications between the base stations and mobile stations, including the CDMA (code division multiple access) and TDMA (time division multiple access) multiplexing schemes, both implemented in the United States and elsewhere under various standards. Generally, in a cellular network, transmissions from the mobile stations to the base stations are across a bandwidth known as the reverse link, while transmissions from the base stations to the mobile stations are across another frequency bandwidth known as the forward link. The forward and reverse links may each comprise a number of traffic channels and signaling or control channels, the former primarily for carrying data, and the latter primarily for carrying the control, synchronization, and other signals required for implementing wireless communications.

Currently, both single-diversity mobile stations and dual-diversity mobile stations are available for voice/data use. Single-diversity, “traditional” mobile stations are those that utilize a single antenna/receiver combination for receiving signals. The more advanced, dual-diversity mobile stations utilize, e.g., dual antennas and receivers or the like, for the simultaneous combining of (or selection from) two independently fading signals, which is meant to increase channel capacity across the forward link. In most cellular networks, the dual- and single-diversity mobile stations are on the same carrier. However, at the base stations, there is no direct way to know which mobile stations have single-diversity capacity and which have dual-diversity capacity. This makes increasing the forward link capacity difficult, since one of the actions necessary to achieve this increase is to be able to reduce the minimum transmission gains for the dual-diversity mobile stations.

### SUMMARY OF THE INVENTION

According to an embodiment of the present invention, a method for optimizing the capacity of a forward link in a cellular telecommunications network involves dynamically adjusting a control setting on the forward link for each mobile station, e.g., the minimum gain level, based on each mobile station's individual performance. The cellular network has one or more base stations and a mixed population of single-diversity mobile stations and dual-diversity mobile stations. In communicating with a particular mobile station, the quality of the transmission over a forward link channel (i.e., physical or logical channel) is monitored at the base station, according to one or more factors. For example, the base station may monitor the reverse link for a power measurement report message (“PMRM”) sent by the mobile station. Depending on the particular configuration of the cellular network, a PMRM may be sent if there are a particular number of frame errors within a particular number of frames, i.e., in such a case the PMRM would indicate poor quality channel conditions. Thus, if no PMRM's are received during a predetermined time period, indicating high quality channel/transmission conditions, then the base station reduces the minimum gain level (or other minimum control setting) by a set amount.

The base station may also monitor the gain level of the transmission over the forward link channel. If the gain level stays at or close to the minimum gain level for a certain time period, and if no PMRM's are received during that time period, indicating high quality channel/transmission conditions, then the base station reduces the minimum gain level by a set amount. The reduction in the minimum gain level can be triggered based on other channel quality factors, such as the forward link frame error rate.

Additional capacity gain on the forward link is achieved by reducing the power allocation to individual mobile stations. Given that the older, single-diversity mobile stations cannot make use of enhancements such as mobile receive diversity, the base station cannot reduce the power allocation for all users and still meet the required quality of service. Hence, the base station is configured to distinguish which mobile stations are capable of supporting lowered power allocation, according to the algorithms described herein.

### BRIEF DESCRIPTION OF THE DRAWINGS

The present invention will be better understood from reading the following description of non-limiting embodiments, with reference to the attached drawings, wherein below:

FIG. 1 is a schematic diagram of a cellular network according to an embodiment of the present invention; and

FIGS. 2-4 are flowcharts showing methods for optimizing forward link capacity, according to various embodiments of the present invention.

### DETAILED DESCRIPTION

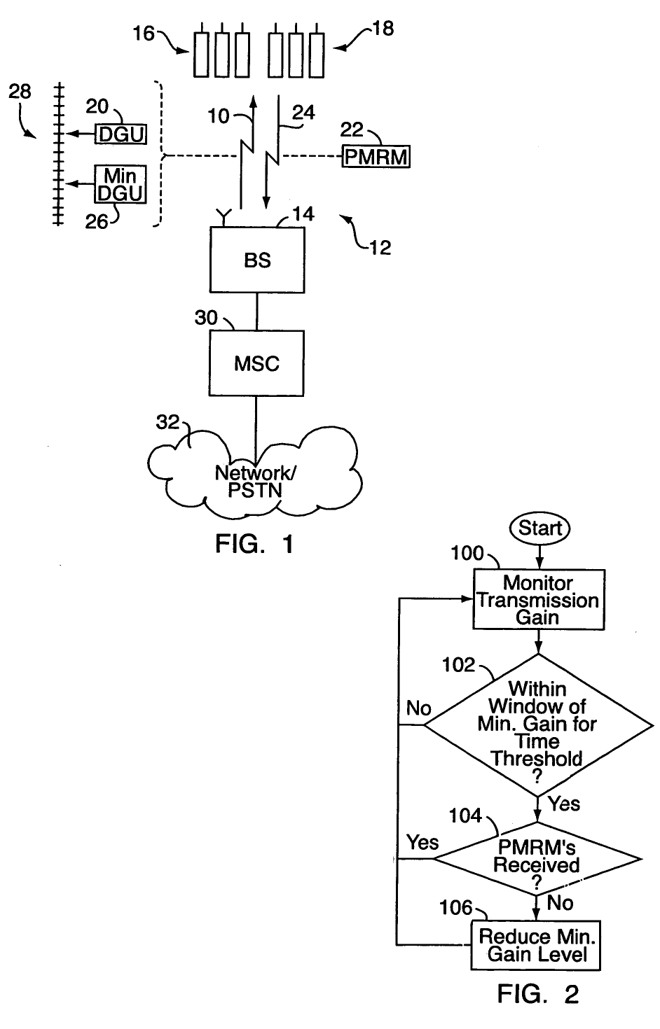

With reference to FIGS. 1-4, an embodiment of the present invention relates to a method for optimizing the capacity of a forward link 10 in a cellular telecommunications network 12 having one or more base stations 14 and a mixed population of single-diversity mobile stations 16 and dual-diversity mobile stations 18. According to the method, minimum gain levels for transmissions across the forward link 10 are dynamically set based on the performance of individual mobile stations. To do so, the amplification/gain level 20 of each transmission over the forward link 10 is monitored at the base station 14. The base station 14 also monitors the reverse link 24 for any power control messages 22 sent by the mobile station 16, 18 engaged in the transmission. If the traffic channel gain level 20 for the transmission stays at or close to a minimum gain level 26 for a certain time period, and if no power control messages 22 (to significantly increase the gain) are received during that time period, then the base station reduces the minimum gain level 26 by a set amount.

As indicated in FIG. 1, the base station 14 will typically be connected to an MSC 30, which will in turn be connected to additional base stations (not shown) and one or more networks 32.

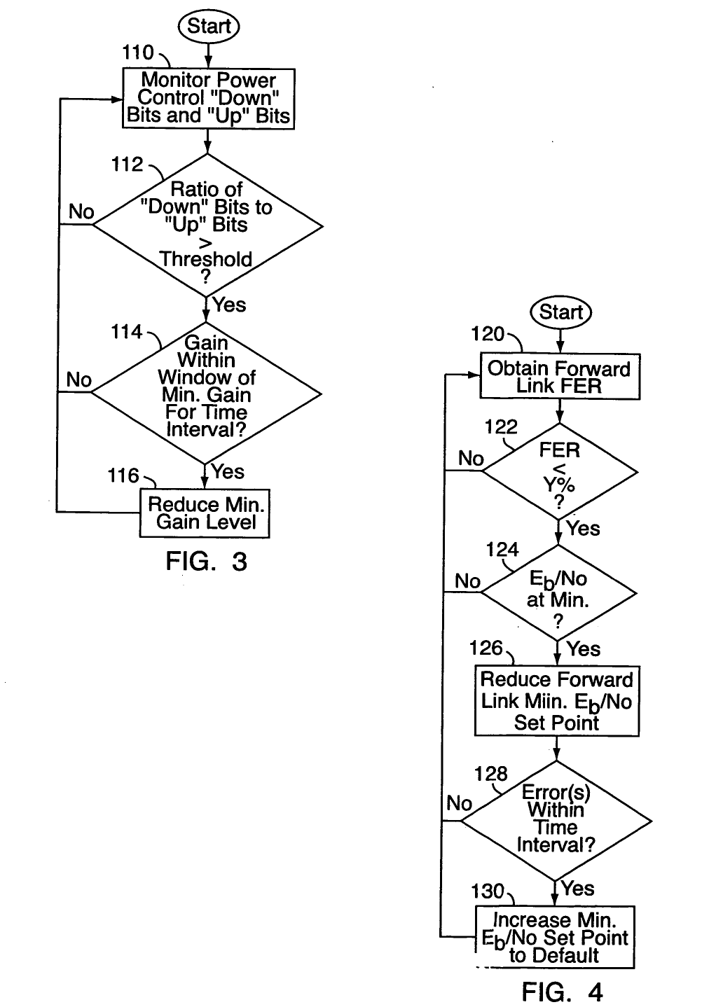

FIG. 2 illustrates the method for optimizing forward link capacity. At Step 100, the base station 14 monitors the amplification or gain level of each call/transmission over the forward link 10. Depending on the particular characteristics of the network and/or base station, the gain level may be analog in nature. More typically, however, with modern equipment, the gain will be monitored and controlled in a digital manner. For example, gain settings may be characterized in terms of digital gain units (“DGU”; units of voltage, power level in dB below a certain reference level, e.g., pilot power), where each DGU represents an incremental increase in power output. Thus, depending on channel conditions, equipment, etc., one transmission might require a DGU of 60 to provide the receiving mobile station 16, 18 with sufficient received power, while another transmission might require a DGU of 67.

As one of the forward link control settings in the base station 14, there will typically be a minimum gain level 26, e.g., a minimum DGU. (More generally, the minimum gain level is a measure of the forward link traffic channel power.) Since the base station 14 will vary the transmission gain level 20 based on power control messages received from the mobile station, the minimum gain level 26 sets a lower limit on this variance, to ensure a minimum signal quality or performance level. Returning to FIG. 2, at Step 102, the base station 14 determines whether or not the gain level 20 of each transmission is at or close to the minimum gain level 26 for a time threshold or period (denoted “T_1”). More specifically, the base station 14 determines whether the gain level 20 is within a particular range or window 28 around the minimum gain level 26. If the gain level 20 is within the window 28 for T_1, at Step 104, the base station determines whether or not any power control messages 22 have been received from the mobile station during T_1. (Steps 102 and 104 may be reversed or performed simultaneously.) T_1 may be selected or optimized by trying out various experimental settings, e.g., a baseline value would be chosen according to expected performance levels/characteristics given the particular network configuration, and then optimized through experimental validation. The optimization may be with respect to fast attack/risk of false alarms, increased FER (frame error rate), loss of quality of service, etc., and in light of the possible tradeoff between a slower, more reliable decision and the loss of possible capacity.

In communicating with a mobile station 16, 18 over the forward link, the voice/data information intended for the mobile station is typically broken into frames at the base station 14. Once the frames are received, the mobile station 16, 18 checks the frames for errors. Periodically, or depending on the number or rate of detected errors, the mobile station 16, 18 generates a power control message 22 as a means of forward link power control or otherwise. The power control message 22 contains an indication of the forward link signal quality, e.g., the error rate. An example of a power control message is the power measurement report message (“PMRM”) generated by mobile stations in certain CDMA-based networks.

At Step 106, if no PMRM's 22 have been received from the mobile station during T_1, the base station 14 lowers the minimum gain level 26 by “X₁” dB for the transmission, where X₁ is in 1 or 2 dB steps. Conceptually, having the gain level 20 at or close to a minimum gain level 26 for the time interval T_1, without any power control messages providing feedback of an unacceptable error rate or the like, is an indication of a high quality channel/signal. Since transmit power and signal quality are related, this means that the minimum gain level 26 can be decreased without likely significantly affecting channel quality. Lowering the transmit power, besides reducing resources expended by the base station (e.g., electrical power), tends to increase channel capacity because of lowered interference with other radio channels. Additionally, since the minimum gain level 26 is set based on individual mobile station performance, the present method allows for the lowering of minimum gains (capacity allocations) for those mobile stations exhibiting superior performance, e.g., the dual-diversity mobile stations 18. This is also the case for mobile stations, dual-diversity or otherwise, positioned in areas with exceptionally good RF conditions.

As noted above, the base stations 14 will typically also use the PMRM's 22 (or other control messages) to adjust the digital gain level 20. For example, if a PMRM 22 indicates a high error rate, the gain level 20 may be adjusted upwards for an increase in transmit power, to reduce the error rate. Similarly, if a PMRM 22 indicates a low error rate, the gain level 20 may be adjusted downwards for a decrease in transmit power. Lowering the minimum gain level 26, according to the method above, allows for the further decrease in transmit power levels below the previous minimum level. This optimizes forward link capacity, and enables the base station 14 to take advantage of the performance capabilities of the dual-diversity mobile stations 18. In other words, the minimum gain level 26 is controlled on a mobile-by-mobile basis, with the base station 14 lowering the minimum gain level 26 in situations where warranted, without having to know in advance if the mobile station is dual-diversity or not, or if the mobile station is in an area with good RF conditions.

The cellular network 12 may be configured for the mobile stations 16, 18 to generate a PMRM or other power control message if there are a predetermined number of frame errors within a predetermined number of frames. It may also be the case that a PMRM or other power control message is sent after a particular number of frames are received. For the former, the reception of a PMRM at the base station 14 during interval T_1 indicates (possibly) poor quality channel conditions, meaning that the minimum gain level 26 should probably not be lowered. For the latter, the reception of a PMRM during interval T_1 may or may not indicate poor quality channel conditions, depending on the content of the PMRM. For example, if the PMRM contains a command, request, or other feedback that the transmission gain be significantly increased, that would be an indication of poor quality channel conditions. If there is no such command or request, the channel conditions should be sufficient for lowering the minimum gain level.

FIG. 3 shows an additional embodiment of the method for optimizing forward link capacity, according to the present invention. As indicated, at Step 110, for each transmission to a mobile station, i.e., a mobile call, the base station 14 monitors the ratio of power control “down” bits to power control “up” bits (ratio=down bits÷up bits), and determines at Step 112 if the ratio is greater than a lower threshold value denoted “threshold_1”. The power control down and up bits are generated by the base station 14, according to the communications protocol in place in the cellular network, and based on measurements, e.g., signal-to-noise ratio, of transmissions received from the mobile stations 16, 18 over the reverse link 24. Specifically, the base station 14 measures the signal-to-noise ratio (e.g., Eb/No or the like) of signals received from the mobile stations 16, 18. If the measured value is above a particular value (a high Eb/No), the base station 14 may transmit power control down bits to reduce the transmit power of the mobile station(s). If the measured value is below a particular value (a low Eb/No), the base station 14 may transmit power control up bits to increase the transmit power of the mobile station(s), which will tend to increase the signal-to-noise ratio. If the ratio of power control down bits to power control up bits as generated by the base station 14 is above threshold_1, i.e., more down bits than up bits by a factor of threshold_1, that may be an indication that less power is needed. Threshold_1 may be chosen to validate this indication, based on the particular operational characteristics of the cellular network.

If the ratio is greater than threshold_1, at Step 114, the base station 14 determines whether or not the gain level 20 for the transmission is at the minimum gain level 26 (or within the range 28) for a time interval denoted “T_2”. If so, at Step 116, the minimum gain level (e.g., minimum DGU) 26 is reduced by a value “X₂” dB. X₂ is selected so as to not introduce a large step reduction in the minimum gain level, which might result in the signal gain 20 of a transmission being detrimentally reduced to a low level where, e.g., the call/transmission is lost.

An additional embodiment of the present invention involves optimizing forward link capacity by lowering the minimum gain level 26 based primarily on received power control messages 22. Specifically, for each transmission/call the base station 14 monitors the reverse link 24 for incoming PMRM's 22. If no PMRM's are received during a time interval denoted “T_3”, the minimum gain level 26 may be reduced by a value “X₃” dB, where X₃ is similar in nature to X₂ or X₁.

An additional embodiment of the present invention involves optimizing forward link capacity by lowering the minimum gain level 26 based on the forward link frame error rate (“FFER”). In particular, as noted above, the mobile stations 16, 18 determine whether the frames received from the base station 14 contain errors. This information is transmitted back to the base station 14 as the FFER, as part of the PMRM's, separate messages, or otherwise. If the FFER is less than an upper threshold of “Y”% over a time interval denoted “T_4”, the minimum gain level 26 may be reduced by a value “X₄” dB (again, X₄ may be similar to X₁−X₃). Where an acceptable FFER is typically on the order of no more than 1%, the value Y will be chosen to be under 1, for a resulting upper threshold of 1%.

Since lowering the minimum gain level 26 may result in lower quality transmissions in certain circumstances as transmission conditions change, the base station 14 may be configured to take action to prevent an “overshoot” of the lowered minimum gain level 26. Specifically, if for a particular transmission the mobile station 16, 18 generates a PMRM 22 within a time interval denoted “T_5” from when the minimum gain level 26 was reduced, then the base station 14 increases the minimum gain level 26 by X₂ dB. The minimum gain level 26 may also be increased if there are two PMRM's within a time interval denoted “T_6”. This control action may also be made in a multi-level manner, e.g., increase the minimum gain level 26 by X₂ dB if a PMRM 22 is received within T_5 of when the minimum gain level 26 was lowered, or by X₃ dB if within T_6. The values for T_2−T_6 are selected and optimized in a similar manner as described above for T_1. Though static values are one possible option, these time periods need not be static values. T_1−T_6 may be adapted dynamically based on how some metric is tracking the desired threshold. For example, if the FER is <0.1%, the system could update the minimum gain down at a fixed rate, but when the FER is between 0.1% and 0.3%, the rate of decrease would be slowed down or stopped altogether.

With reference to FIG. 4, forward link capacity can be further optimized by reducing the forward link minimum Eb/No setpoint. Eb/No is the signal-to-noise ratio in a digital communications system, and is specifically defined as the energy per bit to interference density ratio. In effect, Eb/No is a measure of signal quality. For transmitting across the forward link 10, the mobile stations 16, 18 have a forward link Eb/No setpoint (one of several transmission settings). The forward link Eb/No setpoint establishes a desired signal quality level for transmissions across the forward link, which is verified by feedback from the mobile stations 16, 18. The forward link Eb/No setpoint may vary, and the minimum Eb/No setpoint, also set by the base station 14, provides a lower limit for the Eb/No setpoint. However, depending on mobile station performance, channel conditions, etc., it may be beneficial to lower the forward link minimum Eb/No setpoint in situations where doing so would increase capacity (i.e., lower Eb/No generally corresponds to higher capacity) without lowering signal quality metrics such as FER below acceptable limits.

For lowering the minimum Eb/No setpoint, in communicating with a mobile station 16, 18, the base station 14 queries the mobile station for the FFER at Step 120. At Step 122, the base station 14, having received the FFER from the mobile station, determines whether the FFER is less than Y%. If so, at Step 124, the base station 14 estimates whether the Eb/No of the mobile station 16, 18 (either the actual Eb/No or Eb/No setpoint, depending on how the base station tries to infer this state, not directly available) is at or close to the minimum level, i.e., within a particular window or range of the forward link minimum Eb/No setpoint. If so, then the forward link minimum Eb/No setpoint for that specific mobile is reduced, as at Step 126. Additionally, if the mobile station 14, 16 reports an error within a time interval “T_7” from when the minimum Eb/No setpoint is reduced, or if there is a string of errors within a time interval “T_8” (typically longer than T_7), as determined at Step 128, then the base station 14 increases the forward link minimum Eb/No setpoint back to a default value, as at Step 130.

Capacity optimization according to the methods described herein can be coordinated across all the sectors or cells of a call in soft-handoff, or it can be done autonomously at each individual cell or sector. Also, the present invention may be applied to other power control algorithms, depending on how they are implemented in a cellular network. Also, the various methods described herein may be used individually or combined together based on the specific characteristics and details of the technology and equipment used in the cellular network.

As should be appreciated, the act of reducing the minimum gain level 26 can be triggered based on various factors as described above. These factors include the FFER, power control bit ratio, and transmission of PMRM's, and are collectively referred to herein as “channel indicators,” i.e., each of these factors provides some sort of indication of the signal quality across the forward link and/or the condition of the forward link between the base station and mobile station. In deciding whether or not to reduce the minimum gain level, it is determined whether or not the channel indicator falls within a quality range, i.e., a range of values that correspond to high quality channel conditions, depending on the particular channel indicator utilized. Typically, the quality range is implemented as an upper threshold or a lower threshold, as described above. Thus, in utilizing the FFER as a channel indicator, the minimum gain level 26 would be reduced if the FFER is below an upper threshold of a designated percentage (Y%) during a time interval, i.e., quality range is between 0 and less than Y%. The minimum gain level 26 may be reduced based on other channel indicators, or upon various combinations of channel indicators.

Since certain changes may be made in the above-described method for optimizing the forward link capacity from a mixed population of single- and dual-diversity mobile stations, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for optimizing the capacity of a forward link, said method comprising the steps of:
determining a quality characteristic of a transmission across the forward link, wherein the transmission is controlled by at least one setting having a minimum setpoint; and
adjusting the minimum setpoint based at least in part on the determination.

2. The method of claim 1 wherein the minimum setpoint is a minimum forward link Eb/No setpoint.

3. The method of claim 1 wherein the minimum setpoint is a minimum gain level of the forward link.

4. The method of claim 3 wherein:
the step of determining a quality characteristic of the transmission comprises determining if a forward link frame error rate has passed an upper threshold of 1% during a time interval; and,
if not, the step of adjusting the minimum setpoint comprises reducing the minimum gain level of the forward link.

5. The method of claim 4 further comprising the step of:
determining if a transmission gain is within a range from the minimum gain level during the time interval, wherein the step of reducing the minimum gain level is performed only if it is determined that the transmission gain is within the range during the time interval.

6. The method of claim 3 wherein:
the step of determining a quality characteristic of the transmission comprises determining if a power measurement report message (PMRM) is received from a mobile station during a time interval; and,
if not, the step of adjusting the minimum setpoint comprises reducing the minimum gain level of the forward link.

7. The method of claim 6 further comprising the step of:
determining if a transmission gain is within a range from the minimum gain level during the time interval, wherein the step of reducing the minimum gain level is performed only if it is determined that the transmission gain is within the range during the time interval.

8. A method for communicating across a forward link comprising the steps of:
determining if a forward link channel indicator has passed a threshold during a time interval; and
if not, reducing a minimum gain level of the forward link.

9. The method of claim 8 wherein the channel indicator is a forward link frame error rate, and the threshold is an upper threshold of 1%.

10. The method of claim 8 wherein the channel indicator is a power measurement report message (PMRM) generated by a mobile station, and the threshold is an upper threshold of no PMRM's within the time interval.

11. The method of claim 10 further comprising the step of:
raising the minimum gain level if a PMRM is received during a second time interval from when the minimum gain level was reduced.

12. The method of claim 8 further comprising the step of:
raising the minimum gain level if, during a second time interval from when the minimum gain level was reduced, a forward link channel indicator is above an upper threshold or below a lower threshold.

13. The method of claim 8 wherein the minimum gain level is a minimum digital gain unit level.

14. The method of claim 8 wherein the minimum gain level is a traffic channel power level that is below a power level of a forward link pilot channel by a certain dB.

15. The method of claim 8 further comprising the step of:
determining if a transmission gain is within a range from the minimum gain level during the time interval, wherein the step of reducing the minimum gain level is performed only if it is determined that the transmission gain is within the range during the time interval.

16. The method of claim 15 wherein the channel indicator is a power measurement report message (PMRM), and the threshold is an upper threshold of no PMRM's during the time interval.

17. The method of claim 15 wherein the channel indicator is a ratio of power control down bits to power control up bits, and the threshold is a lower threshold of a designated ratio value.

18. The method of claim 15 wherein the minimum gain level is a minimum digital gain unit level or a traffic channel power level that is below a power level of a forward link pilot channel by a certain dB.

19. A method for optimizing the capacity of a forward link, said method comprising the steps of:
for each transmission across a forward link channel, determining if a channel indicator falls within a quality range during a time interval; and
if so, reducing a minimum gain level of the transmission.

20. The method of claim 19 wherein:
the channel indicator is selected from the group consisting of: a forward link frame error rate with a quality range of 0 to less than 1%; and a power measurement report message (PMRM) with a quality range of no PMRM's within the time interval;
and the method further comprises the steps of:
raising the minimum gain level if the channel indicator falls outside the quality range during a second time interval from when the minimum gain level was reduced; and
determining if a gain level of the transmission is within a range of the minimum gain level during the time interval, wherein the step of reducing the minimum gain level is performed only if it is determined that the transmission gain level is within the range during the time interval.
